(19) United States
(12) Patent Application Publication
(10) Pub. No.: US 2012/0205233 A1
(43) Pub. Date: Aug. 16, 2012

(54) METHOD AND APPARATUS FOR PURIFYING WATER

(75) Inventor: Mazen A. Ba-abbad, Riyadh (SA)

(73) Assignee: King Abdul Aziz City For Science and Technology, Riyadh (SA)

(21) Appl. No.: 13/028,163

(22) Filed: Feb. 15, 2011

(51) Int. Cl. C02F 1/04; C02F 1/14; C02F 1/16; B01D 3/04

(52) U.S. Cl. 203/4; 203/10; 202/185.1

(57) ABSTRACT

The present invention provides a method and apparatus for purifying water. The apparatus includes one or more fluid pipes for transporting a hot fluid and a heating unit capable of receiving the hot fluid from the one or more fluid pipes and water. The water is heated using the hot fluid to generate steam and a condensed fluid. The apparatus further comprises one or more steam pipes for transporting the steam and a fluid circulation pipe connected to the heating unit and the at least one fluid pipe. The fluid circulation pipe receives the condensed fluid from the heating unit. At least a portion of each steam pipe is arranged in a heat-exchanging relationship with the fluid circulation pipe for condensing the steam passing through each steam pipe using the condensed fluid to obtain purified water.

### FIELD OF THE INVENTION

The present invention generally relates to purification of water, and more specifically, to a method and apparatus for purifying water using thermal energy.

### BACKGROUND OF THE INVENTION

Rising population and increased urbanization have increased the demand for treated water, particularly healthy potable water. Consequently there has been a demand for apparatuses and processes that derive fresh water from salt water or contaminated water. Contaminated and polluted ground water can be rendered drinkable through a variety of purification processes. For example, such water purification processes include filtration, biological treatment, thermal water desalination, reverse osmosis, and distillation. Reverse osmosis processes typically produce large amounts of concentrated contaminated waste, which may be environmentally hazardous. Further, a ratio of purified water to contaminated water decreases with an increase in level of contamination in the contaminated water. Thus, the reverse osmosis process rejects a large quantity of water. Additionally, in reverse osmosis processes, contaminated water needs pre-filtration, cooling, and chemical treatment prior to being treated. Finally, a membrane used in the reverse osmosis process needs periodic replacement.

In many applications, distillation is regarded as superior to other purification processes due to usefulness of this process in distilling fresh water from salt water, and in removing toxic chemicals from contaminated water. However, a typical distillation process uses filtration operations that generate salts or contaminants as residue when the salt water or the contaminated water is converted into steam. These salts and contaminants left behind as residue cause scaling and “blow-down” in filters. Blow-down is the process that involves settling of mineral deposits in the filters. The scaling and the “blow-down” in the filters, in turn has detrimental effects on purifying ability of the distillation process. Furthermore, in order to efficiently purify the water using the distillation process, the filter requires frequent maintenance to overcome the scaling and the “blow-down”.

Additionally, these distillation processes utilize thermal energy from metered energy or other expensive energy sources for converting the contaminated water into steam. Further, condensation of the steam by bringing the steam to a lower temperature to obtain a purified water also requires expensive forms of energy.

Therefore, there is a need for a method and apparatus for purifying water using thermal energy derived from efficient energy sources and with less water rejects. Additionally there is a need for a process for effective removal of contaminants that remain when contaminated water is converted into the steam.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1A and FIG. 1B illustrate an apparatus for purifying water using thermal energy in accordance with an embodiment of the invention.

FIG. 2 illustrates a lateral view of heating unit including one or more diffusers in accordance with an embodiment of the invention.

FIG. 3 illustrates a steam pipe used within apparatus in accordance with an embodiment of the invention.

FIG. 4A and FIG. 4B illustrate a side view and a perspective view of a water pipe configured with a waste remover in accordance with an embodiment.

FIG. 5 illustrates a drill-bit type waste remover in accordance with an exemplary embodiment of the invention.

FIG. 6 is a flowchart of a method of purifying water using thermal energy in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method and apparatus for purifying water. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide a method and apparatus for purifying water using thermal energy. The apparatus includes one or more fluid pipes for transporting a hot fluid and a heating unit capable of receiving the hot fluid from the one or more fluid pipes and water. The water is heated using the hot fluid to generate steam and a condensed fluid. The apparatus further comprises one or more steam pipes for transporting the steam and a fluid circulation pipe connected to the heating unit and the at least one fluid pipe. The fluid circulation pipe receives the condensed fluid from the heating unit. At least a portion of each steam pipe is arranged in a heat-exchanging relationship with the fluid circulation pipe for condensing the steam passing through each steam pipe using the condensed fluid to obtain purified water.

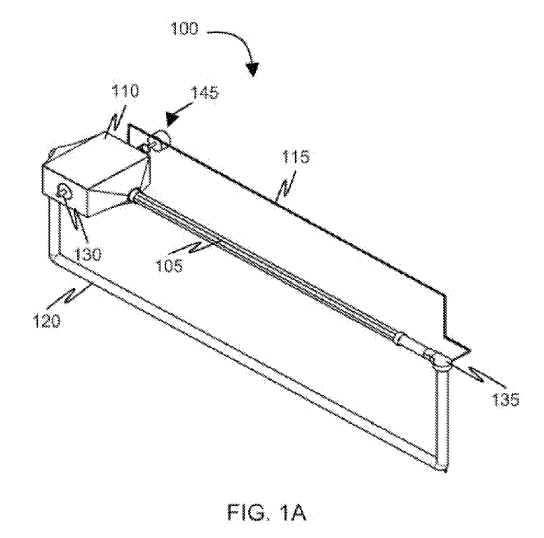

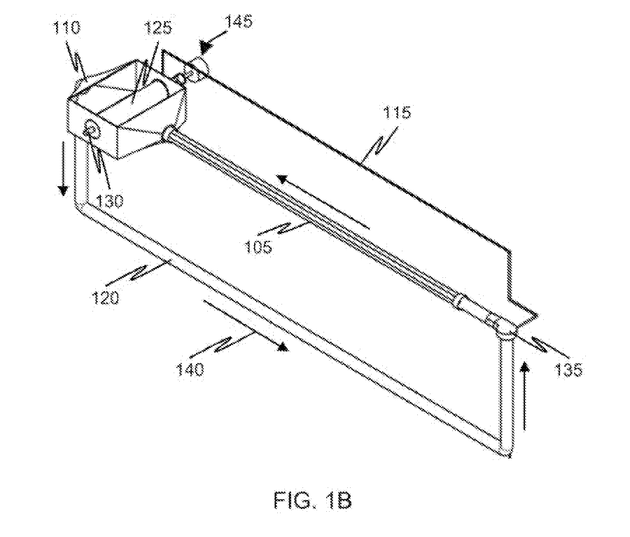

FIG. 1A and FIG. 1B illustrate an apparatus 100 for purifying water using thermal energy in accordance with an embodiment of the invention. The water to be purified in apparatus 100 may be received from any external sources. For example, the water to be purified may include, but is not limited to, salt water, contaminated water, raw water, brine water and sewage water.

Apparatus 100 includes one or more fluid pipes such as, a fluid pipe 105, a heating unit 110, one or more steam pipes such as, a steam pipe 115, a fluid circulation pipe 120, and one or more water pipes such as, a water pipe 125. Apparatus 100 processes the water received from the external sources to provide purified water. The one or more fluid pipes are connected to heating unit 110. The one or more fluid pipes transport and supply a hot fluid to heating unit 110. The hot fluid may include, but is not limited to, air, a gas, a mixture of two or more gases, a liquid, and a mixture of liquids. The hot fluid may be generated by heating a fluid passing through the one or more fluid pipes using thermal energy. In this scenario, the one or more fluid pipes may be configured to receive the thermal energy from one or more thermal energy sources for heating the fluid. The one or more thermal energy sources may include, but is not limited to a solar energy source, a heating coil, a waste process heat source and a geothermal heat source. For example, fluid pipe 105 is configured to receive solar energy from the sun for heating the fluid passing through fluid pipe 105. In an embodiment, a fluid pipe such as, fluid pipe 102 may include an electric heating coil for heating the fluid passing through the fluid pipe. The electric heating coil may be placed within the fluid pipe for heating the fluid. Alternatively, the electric heating coil may be configured in any other location in proximity to the fluid pipe for heating the fluid. However, the fluid may be heated using any other heating mechanisms known in the art.

In an embodiment, the one or more fluid pipes may be positioned in parallel with respect to each other. Alternatively, the one or more fluid pipes may be arranged concentrically with respect to each other. In another embodiment, the one or more fluid pipes may be arranged in a coiled manner or a serpentine manner. However, it would be readily apparent to a person of ordinary skill in the art that the one or more fluid pipes may be positioned at any angle and arranged in any fashion for facilitating the transfer of the thermal energy to the fluid. The hot fluid obtained is then supplied to heating unit 110. The hot fluid is passed into a cavity within heating unit 110. The direction of flow of the hot fluid within apparatus 100 is illustrated by arrows shown in the FIG. 1B.

Heating unit 110 includes one or more water pipes such as, a water pipe 125 for receiving the water. In an embodiment, water pipe 125 is configured within heating unit 110 as illustrated in FIG. 1B. The water is supplied through an inlet 130 of water pipe 125 and allowed to pass through water pipe 125. Thus, a heat exchanging relationship is established between the water and the hot fluid within heating unit 110.

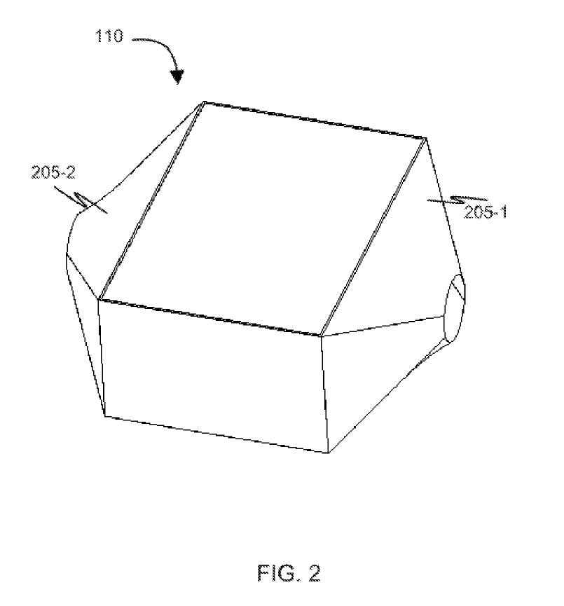

In an embodiment, the hot fluid received from the one or more fluid pipes may be directly passed into heating unit 110. Alternatively, the hot fluid may be compressed using a fluid blower 135 prior to being passed into heating unit 110. Further, the hot fluid may be diffused using one or more diffusers present in heating unit 110. The working of the one or more diffusers is explained in further detail in conjunction with FIG. 2. As a result of the hot fluid being compressed by fluid blower 135 and diffused by the one or more diffusers, the temperature of the hot fluid supplied to heating unit 110 may be high. It may be readily apparent to a person skilled in the art that the hot fluid may be compressed using any techniques known in the art. The thermal energy dissipated from the hot fluid increases the temperature within heating unit 110. The thermal energy is then transferred from the hot fluid to the water thereby converting the water into steam within the one or more water pipes such as, water pipe 125. The thermal energy may be consumed completely for generation of the steam thereby providing apparatus 100 without any water rejects. Due to this transfer of the thermal energy, the hot fluid is converted into a condensed fluid. The condensed fluid is then passed through fluid circulation pipe 120 connected to heating unit 110. This is indicated by arrows such as, an arrow 140 in FIG. 1B.

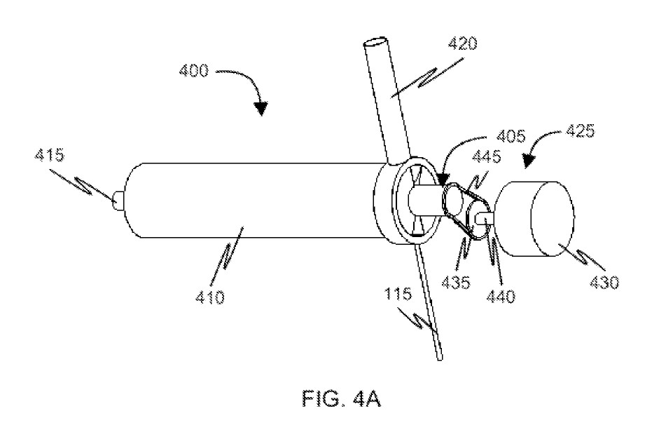

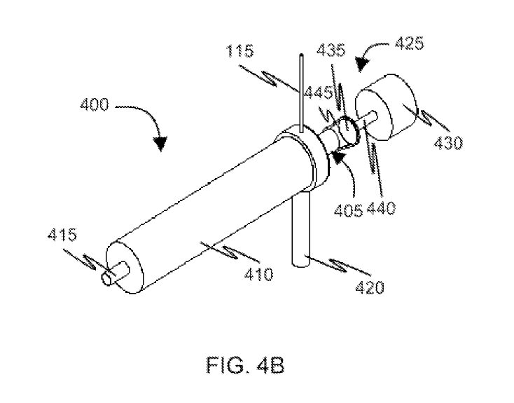

The steam is collected by the one or more steam pipes such as, steam pipe 115 from heating unit 110. In an embodiment, the one or more steam pipes such as, steam pipe 115 may be connected to one or more water pipes such as, water pipe 125 for collecting the steam. In response to converting the water into the steam, waste matter may settle within the one or more water pipes. The waste matter may be, for example, but not limited to salts and contaminants. Further, since the water is converted into the steam, the waste matter that remains in heating unit 110 may be solid waste matter. The waste matter may be removed using one or more waste removers such as, a waste remover 145. A waste remover of the one or more waste removers used for the removal of the waste matter is described in detail in conjunction with in FIG. 4A and FIG. 4B. Thus, apparatus 100 may not discharge any liquid waste, thereby preventing environmental contamination that may result from discharge of the waste matter as the liquid waste.

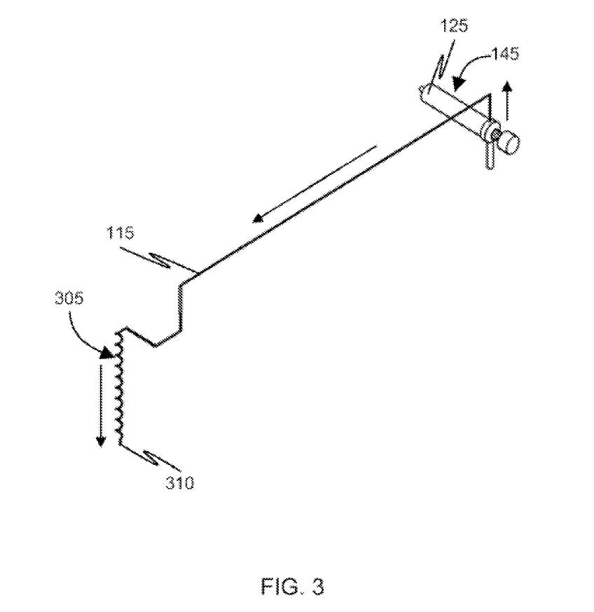

The steam collected is then condensed using the condensed fluid passing through fluid circulation pipe 120. More specifically, at least a portion of steam pipe 115 may be positioned within fluid circulation pipe 120 to form a heat-exchanging relationship between steam pipe 115 and fluid circulation pipe 120. Thus, a transfer of heat energy occurs from the steam to the condensed fluid to obtain a purified water. The process of condensing the steam within apparatus 100 is explained in detail in conjunction with FIG. 3.

FIG. 2 illustrates a lateral view of heating unit 110 including the one or more diffusers, such as a diffuser 205-1 and a diffuser 205-2 in accordance with an embodiment of the invention. FIG. 2 illustrates two diffusers such as, diffuser 205-1 and diffuser 205-2. However, it will be readily apparent to a person skilled in the art that heating unit 110 may include more than two diffusers. Diffuser 205-1 and diffuser 205-2 may have a shape, but is not limited to a tapered shape, a rectangular shape, a conical shape and a pyramidal shape. Diffuser 205-1 and diffuser 205-2 are illustrated in FIG. 2 as part of heating unit 110. However, diffuser 205-1 and diffuser 205-2 may be separate units that are connected to heating unit 110 for diffusing the hot fluid entering heating unit 110. Diffuser 205-1 and diffuser 205-2 may be connected to the one or more fluid pipes such as, fluid pipe 105 to receive the hot fluid.

Diffuser 205-1 facilitates transfer of the thermal energy from the hot fluid to the water passing through the one or more water pipes such as, water pipe 125, to convert the water into the steam. When the hot fluid flows through diffuser 205-1, the hot fluid is allowed to diffuse from a smaller area towards a larger area. In an embodiment, the speed of the hot fluid with diffuser 205-1 may be below the speed of sound. Thus, when the hot fluid moves from the smaller area to the larger area, speed of the hot fluid reduces and the pressure and temperature of the hot fluid increases. As a result, the heat energy from the hot fluid is efficiently transferred to the water passing through the one or more water pipes such as, water pipe 125. Diffuser 205-1 may also allow efficient flow of the hot fluid from the one or more fluid pipes into heating unit 110 by reducing resistance. Diffuser 205-2 is connected to fluid circulation pipe 120 for circulating the condensed fluid out of heating unit 110.

The steam generated within the one or more water pipes such as, water pipe 125 is then converted into the purified water. A steam pipe such as, steam pipe 115 is used to collect the steam from water pipe 125. FIG. 3 illustrates steam pipe 125 used in apparatus 100. The direction of flow of the steam within steam pipe 115 is illustrated by arrows in FIG. 3. In an embodiment, there may be two or more steam pipes arranged in parallel and connected to the one or more water pipes. For example, a first steam pipe, a second steam pipe and a third steam pipe may be transporting the steam from the one or more water pipes. These three steam pipes may be positioned in parallel with respect to each other. However, it will be readily apparent to a person of ordinary skill in the art that the three steam pipes may be arranged in any manner for transferring the steam from the one or more water pipes.

The steam transferred is then condensed using the condensed fluid received from heating unit 110. A fluid circulation pipe such as, fluid circulation pipe 120 used to circulate the condensed fluid out of heating unit 110, may be connected to the one or more steam pipes, such as steam pipe 115. At least a portion such as, a portion 305 of steam pipe 115 may be arranged in a heat exchanging relationship with the fluid circulation pipe for condensing the steam. For example, portion 305 of steam pipe 115 may be configured within the fluid circulation pipe such as, fluid circulation pipe 120 to establish the heat exchanging relationship. The steam passes through steam pipe 115 to reach portion 305. The steam is then condensed to obtain the purified water using the condensed fluid circulated within the fluid circulation pipe.

In an embodiment, portion 305 may be coiled within the fluid circulation pipe. As portion 305 is coiled, surface area available for facilitating the heat exchange between the steam and the condensed fluid is increased. Due to the increased surface area, efficient transfer of heat energy from the steam to the condensed fluid may be achieved. Transfer of the heat energy of the steam to the condensed fluid may result in reuse of the latent heat by an apparatus such as, apparatus 100. In another embodiment, portion 305 may be tapered at the top and widened at the bottom, thereby allowing the steam to diffuse while passing through portion 305. However, it will be readily apparent to a person skilled in the art that portion 305 may be configured in any other manner to enable efficient transfer of the heat energy from the steam to the condensed fluid.

The purified water obtained after the condensation is collected through a purified water outlet 310. Further, a heated fluid received after the condensation of the steam may be circulated into the one or more fluid pipes by the fluid circulation pipe. Alternatively, the heated fluid may be compressed using a fluid blower such as, fluid blower 135. As described in conjunction with FIG. 1A and FIG. 1B, the fluid blower may be connected to the fluid circulation pipe and the one or more fluid pipes. The compressed fluid may be then circulated into the one or more fluid pipes. Thereafter, the compressed fluid is further heated using the thermal energy and supplied to the heating unit such as, heating unit 110.

Now referring back to the waste matter generated within the one or more water pipes such as, water pipe 125, the waste matter needs to be continuously removed from the water pipe. Thus, the waste matter may be removed from each water pipe using a waste remover. FIG. 4A and FIG. 4B illustrate a side view and a perspective view of a water pipe 400 configured with a waste remover 405 in accordance with an embodiment. Water pipe 400 includes a water storage unit 410. The water enters water storage unit 410 through an inlet 415 of water pipe 400. Water storage unit 410 may be provided with corrosion resistant walls. For example, inner walls of water storage unit 410 may be manufactured using corrosion resistant materials such as, but not limited to, stainless steel, nickel alloy, chromium alloy, and titanium alloy. The thermal energy from the hot fluid causes the water to be converted to the steam within water pipe 400. As illustrated in FIG. 4A and FIG. 4B, steam pipe 115 may be connected to water pipe 400 for allowing the steam to pass through to be converted into the purified water. The conversion of the water to the steam leaves behind the waste matter in water storage unit 410. The waste matter may be left behind without any water rejects from the apparatus such as, apparatus 100. The waste matter is removed continuously using waste remover 405. In an embodiment, waste remover 405 may rotate within water pipe 400 for removing the waste matter. Waste remover 405 may be, for example a drill-bit type waste remover or a screw type waste remover. Alternatively, waste remover 405 may be a suction type waste remover capable of removing the waste matter using suction pressure. However, it will be readily apparent to person skilled in the art that any other waste remover may be used for removing the waste matter from water pipe 400. The waste matter removed from water pipe 400 may be allowed to be disposed out of water pipe 400 through a waste matter outlet 420.

Waste remover 405 may driven by a driving unit 425. In an embodiment, driving unit 425 may include a motor unit 430 connected to a pulley 435 through a shaft 440. Pulley 435 is connected to waste remover 405 using a belt 445. In this case, when motor unit 430 is operated, shaft 440 rotates. Consequently, pulley 435 operates to run belt 445 in order to rotate waste remover 405. In another embodiment, driving unit 425 may include a motor unit connected to a gear through a shaft. The gear may be connected to a shaft of the waste remover using a belt. When the shaft connected to the motor unit rotates, the gear rotates to operate the shaft connected to the waste remover. Thus, the waste remover operates within the water pipe such as, water pipe 400 or water pipe 125 to remove the waste matter. It will be readily apparent to a person skilled in the art that driving unit 425 may be any other driving units known in the art, but not limited to a belt driving unit, a viscous torque coupling driving unit and a chain driving unit.

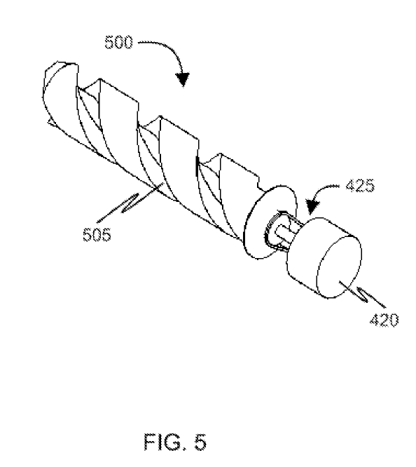

Now moving to FIG. 5 that illustrates a drill-bit type waste remover 500 in accordance with an exemplary embodiment of the invention. Drill-bit type waste remover 500 may be configured within a water pipe such as, water pipe 400 or water pipe 125. Drill-bit type waste remover 500 includes one or more grooves, such as a groove 505. Drill-bit type waste remover 500 may include the one or more grooves arranged in any fashion for removing the waste matter from the water pipe. Drill-bit type waste remover 500 is driven by a driving unit such as, driving unit 425. During operation, drill-bit type waste remover 500 rotates within the water pipe. In response to rotation, the waste matter is carried through groove 505 and subsequently passes through a waste outlet such as, waste matter outlet 420. The removal of the waste matter from the water storage unit prevents scaling and “blow-down” from occurring in a water storage unit such as, water storage unit 410. Drill-bit type waste remover 500 may be composed of corrosion resistant materials such as but not limited to, stainless steel, nickel alloy, chromium alloy, and titanium alloy.

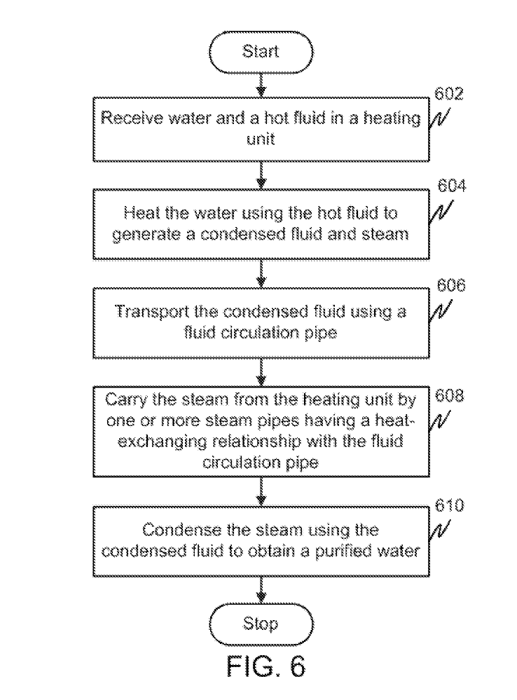

FIG. 6 is a flowchart of a method of purifying water using thermal energy in accordance with an embodiment of the invention. A fluid is heated in one or more fluid pipes using the thermal energy from one or more thermal energy sources to obtain a hot fluid. The thermal energy source may be, for example but is not limited to a solar energy source, a waste process heat source and a geothermal heat source. At step 602, the water and the hot fluid is received in a heating unit. For example, the water and the hot fluid may be received within heating unit 110 of apparatus 100. The water may pass through one or more water pipes such as, water pipe 125 configured within heating unit 110. In this case, the water passing through water pipe 125 may be in heat-exchanging relationship with the hot fluid within heating unit 110. Thus, a thermal energy is transferred from the hot fluid to the water. The thermal energy thus transferred facilitates in heating of the water to generate condensed fluid and steam, at step 604. In response to conversion of the water into the steam, waste matter may be left behind in the heating unit. The waste is explained in conjunction with FIGS. 1A and 1B. The waste matter may be then removed from the heating unit using one or more waste removers such as, waste remover 405. Further, the condensed fluid may be transported or circulated using one or more fluid circulation pipes connected to the heating unit at step 606. This is explained in conjunction with FIG. 1A and FIG. 1B.

Thereafter, at step 608 the steam is carried from the heating unit by one or more steam pipes. The one or more steam pipes may have a heat-exchanging relationship with the one or more fluid circulation pipes. For example, at least a portion of a steam pipe may be configured within a fluid circulation pipe to establish a heat-exchanging relationship between the steam and the condensed fluid flowing through the fluid circulation pipe. In an embodiment, the steam is transported through a coiled portion of a steam pipe configured within the fluid circulation pipe for condensing the steam. The arrangement of the portion of the steam pipe within the fluid circulation pipe is explained in conjunction with FIG. 4A and FIG. 4B. The steam transported through the one or more steam pipes is condensed by exchanging heat energy with the condensed fluid to obtain purified water at step 610.

Moreover, the condensed fluid is converted into a heated fluid within the one or more fluid circulation pipes in response to condensation of the steam. Thereafter, the heated fluid is supplied to the one or more fluid pipes to be further heated using the one or more thermal energy sources. In an embodiment, the heated fluid is compressed prior to circulating a compressed fluid into the one or more fluid pipes. The hot fluid thus obtained in the one or more fluid pipes is then delivered to the heating unit. This is explained in detail in conjunction with FIG. 1A and FIG. 1B.

Various embodiments of the invention provide a method and apparatus for purifying water using thermal energy. The method includes receiving water and hot fluid in a heating unit. The received water is converted into steam using the thermal energy of the hot fluid. The thermal energy is received from a thermal energy source, such as, for example a solar energy source, a waste process heat source, or a geothermal heat source. Therefore, the apparatus converts the water into the purified water using an energy source that is less expensive. Further, as the steam is condensed using a condensed fluid circulated from the heating unit to obtain the purified water, a latent heat of the steam is used for re-heating the condensed fluid. This heated fluid is then supplied back to the heating unit for heating the water such as, raw water. Thus, apparatus re-uses the latent heat of the steam for conversion of the raw water to obtain a purified water.

The conversion of the water into the steam leaves behind waste matter in the one or more water pipes. However, the apparatus includes one or more waste removers used for continuously removing the waste matter from the one or more water pipes. The removal of the waste matter prevents scaling and “blow-down” from occurring in a water storage unit of a water pipe. This continuous removal of the waste matter from the heating unit allows usage of water with high concentrations of salts or high levels of contamination to be purified effectively.

The steam obtained is transported from the heating unit by a steam pipe. The steam pipe may be configured to have a heat-exchanging relationship with a fluid circulation pipe. Therefore, a portion of the steam pipe is configured within a fluid circulation pipe to facilitate the exchange of heat energy between the condensed fluid passing through the fluid circulation pipe and the steam to obtain purified water. Thus, the apparatus is designed in a compact manner such as to re-circulate the fluid within the apparatus for heating the raw water to obtain a purified water.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

What is claimed is:

1. An apparatus for purifying water, the apparatus comprising:
at least one fluid pipe for transporting a hot fluid;
a heating unit capable of receiving the hot fluid from the at least one fluid pipe and water, wherein the water is heated using the hot fluid to generate steam and a condensed fluid;
at least one steam pipe for transporting the steam; and
a fluid circulation pipe connected to the heating unit and the at least one fluid pipe, the fluid circulation pipe capable of receiving the condensed fluid from the heating unit, wherein at least a portion of each steam pipe is arranged in a heat-exchanging relationship with the fluid circulation pipe for condensing the steam passing through each steam pipe using the condensed fluid to obtain purified water.

2. The apparatus of claim 1, wherein the heating unit comprises at least one diffuser, wherein the at least one diffuser is connected to the fluid circulation pipe and the at least one fluid pipe, the at least one diffuser facilitates transfer of the thermal energy from the hot fluid to the water to obtain the steam.

3. The apparatus of claim 1, wherein the heating unit comprises at least one water pipe configured therewithin to receive the water.

4. The apparatus of claim 3 further comprising at least one waste remover, a waste remover of the at least one waste remover is connected to a water pipe of the at least one water pipe, wherein the waste remover is capable of removing waste matter from the water pipe obtained in response to converting the water into the steam.

5. The apparatus of claim 4, wherein the waste remover is one of a drill-bit type waste remover and a screw type waste remover.

6. The apparatus of claim 3, wherein the at least one steam pipe is connected to the at least one water pipe for collecting the steam generated within the at least one water pipe.

7. The apparatus of claim 1, wherein the portion of each steam pipe is configured within the fluid circulation pipe to form the heat-exchanging relationship between the fluid circulation pipe and the steam pipe.

8. The apparatus of claim 1, wherein the fluid circulation pipe supplies a heated fluid obtained in response to condensation of the steam using the condensed fluid.

9. The apparatus of claim 8 further comprising a fluid blower connected to the at least one fluid pipe and the fluid circulation pipe, wherein the fluid blower is capable of:
compressing the heat fluid received from the fluid circulation pipe; and
supplying the compressed fluid to the at least one fluid pipe.

10. The apparatus of claim 8, wherein the at least one fluid pipe is configured to receive thermal energy from at least one thermal energy source for heating the heated fluid passing through the at least one fluid pipe to generate the hot fluid.

11. The apparatus of claim 9, wherein the at least one thermal energy source comprises a solar energy source, a waste process heat source, and a geothermal heat source.

12. A method of purifying water, the method comprising:
receiving water and a hot fluid in a heating unit, wherein the water is received within at least one water pipe comprised within the heating unit;
heating the water using the hot fluid to generate a condensed fluid and steam;
transporting the condensed fluid using a fluid circulation pipe;
carrying the steam from the heating unit by at least one steam pipe having a heat-exchanging relationship with the fluid circulation pipe; and
condensing the steam using the condensed fluid to obtain a purified water.

13. The method of claim 12 further comprising removing waste matter obtained in response to generating the steam from the at least one water pipe.

14. The method of claim 12 further comprising:
supplying a heated fluid to at least one fluid pipe by the fluid circulation pipe, wherein the heated fluid is obtained in response to condensing the steam using the condensed fluid;
heating the heated fluid in the at least one fluid pipe using at least one thermal energy source to obtain the hot fluid; and
delivering the hot fluid to the heating unit.

15. The method of claim 14, wherein the at least one thermal energy source comprises a solar energy source, a waste process heat source, and a geothermal heat source.
